(19) United States
(12) Patent Application Publication
(10) Pub. No.: US 2016/0274894 A1
(43) Pub. Date: Sep. 22, 2016

(54) UPDATE SUPPORT APPARATUS AND METHOD

(71) Applicant: KABUSHIKI KAISHA TOSHIBA, Tokyo (JP)

(72) Inventors: Yuji Shimizu, Kawasaki Kanagawa (JP); Tomohiro Yamasaki, Tokyo (JP); Masayuki Ashikawa, Kawasaki Kanagawa (JP); Noriko Yamanaka, Kawasaki Kanagawa (JP); Makoto Yajima, Tachikawa Tokyo (JP); Yuichi Miyamura, Yokohama Kanagawa (JP)

(21) Appl. No.: 15/064,476

(22) Filed: Mar. 8, 2016

(30) Foreign Application Priority Data
Mar. 18, 2015 (JP) 2015-055089

(51) Int. Cl. G06F 9/445; G06F 9/44

(52) U.S. Cl. CPC G06F 8/65; G06F 8/71

(57) ABSTRACT

According to one embodiment, an update support apparatus includes a first storage, a second storage, an extractor and a presenter. The first storage stores an identifier, word information, and an update history which are associated with each other. The second storage stores dictionary entries in each of which the identifier and the update history are associated with each other for each version of one or more dictionaries which use the word information. The extractor extracts one or more update candidates from the second storage, the one or more update candidates each being a dictionary entry having the identifier stored in the first storage and an update history different from the update history stored in the first storage. The presenter presents the one or more update candidates to a user.

### CROSS-REFERENCE TO RELATED APPLICATIONS

This application is based upon and claims the benefit of priority from Japanese Patent Application No. 2015-055089, filed Mar. 18, 2015, the entire contents of which are incorporated herein by reference.

### FIELD

Embodiments described herein relate generally to an update support apparatus and method.

### BACKGROUND

Examples of natural language services used on the Internet include automatic translation, speech synthesis, and big data analysis. Highly accurate language analysis is vital for the expansion or sophistication of these services. In order to improve the accuracy of language analysis, a so-called word dictionary in which headwords are associated with a part of speech, a reading, and other various information, has to be improved.

The word dictionary has been created somewhat automatically; however, in reality manual operation is still often necessary. When creating a word dictionary, an administrator has to do word registration and modification of attached information sequentially. This decreases efficiency.

A conventional technique for simultaneously managing a word dictionary by a plurality of administrators has been used. With this conventional technique, words shared by multiple dictionaries can be integrally maintained, thereby improving efficiency in dictionary development.

### BRIEF DESCRIPTION OF THE DRAWINGS

FIG. 1 is a block diagram illustrating an update support apparatus according to the present embodiment.

FIG. 2 illustrates an example of a data structure stored in a word information database.

FIG. 3 illustrates an example of a data structure stored in a dictionary management database.

FIG. 4 shows an example of an updated dictionary management database.

FIG. 5 is a flowchart showing a dictionary update process of a dictionary update apparatus according to the second embodiment.

FIG. 6 illustrates an example of a data structure stored in a dictionary management database according to the third embodiment.

FIG. 7 is a flowchart showing a dictionary update process of a dictionary update apparatus according to the fourth embodiment.

FIG. 8 illustrates an example of a data structure stored in a word information database according to the fifth embodiment.

FIG. 9 illustrates an example of a data structure stored in a dictionary management database according to the fifth embodiment.

FIG. 10 illustrates an example of a word information database when multiple readings are associated.

FIG. 11 illustrates an example of a dictionary management database when multiple readings are associated.

### DETAILED DESCRIPTION

If a word information entry shared by a plurality of dictionaries is modified, the plurality of dictionaries must be updated at the time of modification. However, the need to update may vary depending on the dictionaries. For example, information for a particular word should be updated later, not at the current stage, but information for the other words should be updated immediately.

If each dictionary selectively adopts shared word information, and word information that has not been adopted is managed independently by each dictionary, the significance of sharing word information diminishes. As a result, the management method will be returned to that before sharing information where each dictionary independently manages word information.

In general, according to one embodiment, an update support apparatus includes a first storage, a second storage, an extractor and a presenter. The first storage stores word entries in each of which an identifier to identify a word, word information for the word, and an update history of the word information are associated with each other. The second storage stores dictionary entries in each of which the identifier and the update history are associated with each other for each version of one or more dictionaries which use the word information. The extractor extracts one or more update candidates from the second storage, the one or more update candidates each being a dictionary entry having the identifier stored in the first storage and an update history different from the update history stored in the first storage. The presenter presents the one or more update candidates to a user.

Hereinafter, the update support apparatus and method according to the present embodiments will be described in detail with reference to the drawings. In the following embodiments, elements which perform the same operation will be assigned the same reference symbols, and redundant explanations thereof will be omitted as appropriate.

### First Embodiment

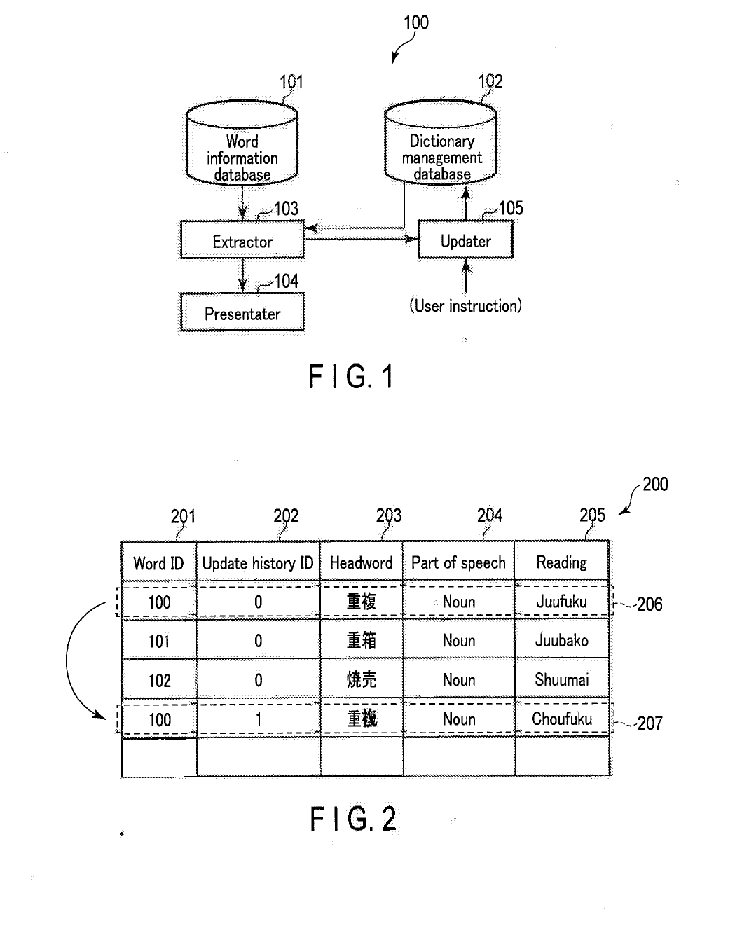

An update support apparatus according to the present embodiment will be explained with reference to the block diagram shown in FIG. 1.

An update support apparatus 100 according to the first embodiment includes a word information database 101 (also referred to as a first storage), a dictionary management database 102 (also referred to as a second storage), an extractor 103, a presenter 104, and an updater 105.

The word information database 101 stores a word entry in which a word ID which is an identifier to identify a word, word information which is information relating to a word, and an update history ID which is version information relating to the update of word information that is associated with each other. The word information database 101 will be described later with reference to FIG. 2.

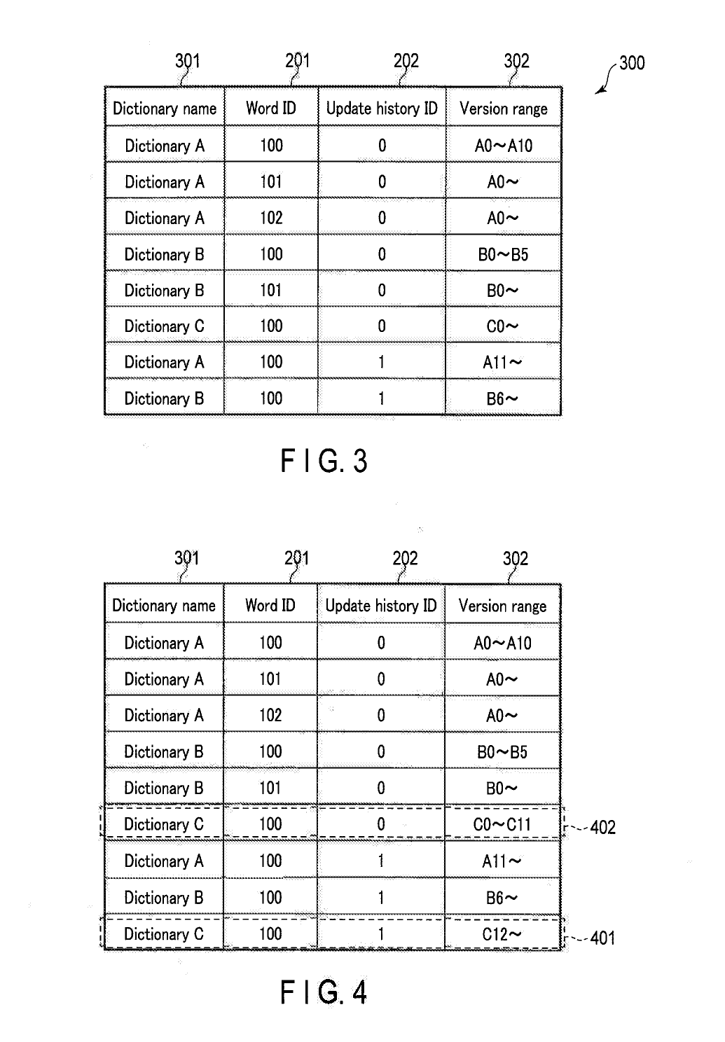

The dictionary management database 102 stores information relating to one or more dictionaries that use word entries stored in the word information database 101. Specifically, the dictionary management database 102 stores a word ID and an update history ID for each version of one or more dictionaries that use word information. The word ID and the update history ID are the same as those stored in the word information database 101. The dictionary management database 102 will be described later with reference to FIG. 3.

The extractor 103 receives a word entry that has the latest update history ID from the word information database 101. The extractor 103 extracts one or more update candidates having the same word ID as that of the word entry having the latest update history ID, and an update history ID different from the latest update history ID from among the word IDs stored in the dictionary management database 102. The extractor 103 may perform the above extraction processing when the word information database 101 is updated, at regular intervals, or in accordance with a user instruction.

The presenter 104 presents one or more update candidates to the user. The presenter 104 may present the one or more update candidates on a display along with a message to the user to ask whether or not to update each update candidate. The user determines whether or not to update word information corresponding to the respective word IDs presented as update candidates. The update candidates may be presented to the user when the word information database 101 is updated, at regular intervals, or at any suitable timing.

If an instruction to update an update candidate is received from the user, the updater 105 receives from the extractor 103 the update candidate designated by the user among the one or more update candidates. The updater 105 updates an update history ID of the update candidate designated by the user to the latest update history ID stored in the word information database 101.

Next, an example of data structure stored in the word information database 101 will be explained with reference to FIG. 2.

The word information database 101 stores table 200 as shown in FIG. 2 as a data structure. Table 200 stores word entries 206 in each of which a word ID 201, an update history ID 202, a headword 203, a part of speech 204, and a reading 205 are associated with each other.

The headword 203 is a headword of each word. The part of speech is a part of speech of each word. The reading 205 is a phonetic spelling of each word. A combination of the headword 203, the part of speech 204, and the reading 205 is referred to as word information. Information included in word information is not limited thereto, and may include an accent, a category, a frequency of use, a meaning marker information relating to the basic meaning of a word, or a translation information.

For example, table 200 stores a word entry 206 in which a word ID 201, “100”, an update history ID 202, “0”, a headword 203, “ [symbol] ”, a part of speech 204, “Noun”, and a reading 205, “juufuku”, are associated with each other.

If the word information is updated, a new word entry is added. In the example of FIG. 2, if the reading for “ [symbol] [symbol] ” is updated to “choufuku”, a new word entry 207 is created and added at the bottom of the table 200. Specifically, the word entry 207 includes a word ID 201, “1”, an update history ID 202, “1”, an a headword 203, “ [symbol] [symbol] ”, a part of speech 204, “Noun”, and a reading 205, “choufuku”, that are associated with each other.

That is, the word entry 207 is different from the word entry 206 merely in the update history ID 202 (“1”) and the reading 205 (“choufuku”). The update history ID indicates that the word information is updated.

Next, an example of a data structure stored in the dictionary management database 102 will be explained with reference to FIG. 3.

The dictionary management database 102 stores table 300 as shown in FIG. 3 as a data structure. Table 300 stores dictionary entries in each of which a dictionary name 301, a word ID 201, an update history ID 202, and a version range 302 are associated with each other.

The dictionary name 301 indicates a name of a dictionary. The version range 302 indicates version information of a dictionary that uses a word entry having a particular word ID 201. The version of each dictionary is represented by “A0”, “B5”, etc. The version range 302, for example, “A0˜” which is open-ended, represents that the word information corresponding to a particular word ID 201 is currently being used from the version “A0” of dictionary A. On the other hand, the version range 302, for example, “A0˜A10”, which is not open-ended, represents that the word information corresponding to a particular word ID 201 was used from the version “A0” to “A10” of dictionary A.

For example, table 300 stores a dictionary entry in which a dictionary name 301, “Dictionary A”, a word ID 201, “100”, an update history ID 202, “0”, and a version range 302, “A0˜A10”, are associated with each other.

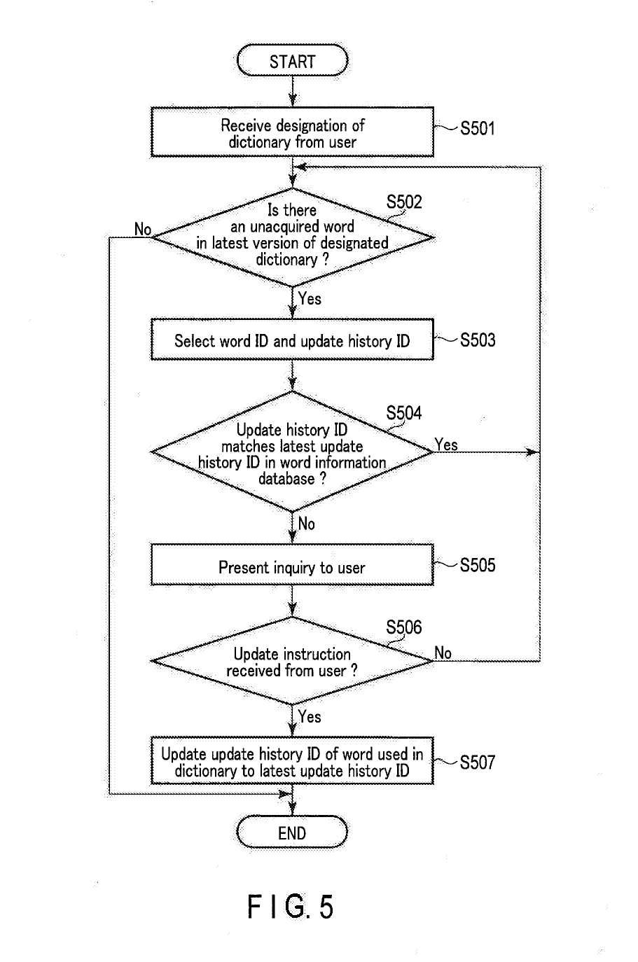

Next, an example of a specific update of the dictionary management database 102 will be explained with reference to FIG. 4.

In this example, it is assumed that information for the word ID 201, “100” and the update history ID 202, “0”, is updated. In addition, it is assumed that the word information database 101 has a word entry for the word ID 200, “100”, having the latest update history ID 202, “1”, as shown in FIG. 2.

The extractor 103 extracts an update candidate having a word ID the same as that stored in the word information database 101, and a update history ID different from that stored in the word information database 101 from the dictionary management database 102 shown in FIG. 3. In FIG. 4, a dictionary entry having a dictionary name “Dictionary C”, word ID “100”, and update history ID “0” is the same in word ID and different in update history ID, in comparison with the word entry having the word ID “100” and the update history ID “1” stored in the word information database 101. Accordingly, the dictionary entry having dictionary name “Dictionary C”, word ID “100”, and update history ID “0” is extracted as an update candidate.

The presenter 104 presents a message to ask the user whether or not to update information on word ID “100” of Dictionary C.

If the updater 105 receives from the user an instruction to update the information on word ID “100” of Dictionary C, the updater 105 adds a new dictionary entry to the dictionary management database 102.

FIG. 4 shows an example of an updated dictionary management database 102.

Specifically, if it is assumed that the current version of Dictionary C is “C11”, and a new dictionary entry 401 having a dictionary name 301 “Dictionary C”, a word ID 201 “100”, an update history ID 202 “1”, and a version range 302 “C12˜” is stored. In addition, the version range 302 “C0˜” of the previous dictionary entry 402 is modified to “C0˜C11” by the updater 105.

By the above processing, it is indicated that the word entry having a word ID “100” and an update history ID “0”, i.e., the reading “juufuku”, had been applied for the version range “C0˜C11” of Dictionary C. In addition, it is indicated that the word entry having a word ID “100” and an update history ID “1”, i.e., having the reading “choufuku”, has been used since the version range “C12” of Dictionary C.

If the user instructs to not update the dictionary entry for word ID “100” to information on update history ID “1”, no update is performed to the dictionary management database 102.

According to the first embodiment described above, if word information is updated, an update candidate having the same word ID and the different update history ID is presented to the user so that the user can update dictionary entries as needed. Based on the above processing, the costs involved in updating can be reduced, and the user's desire of updating word information not immediately, but later in accordance with the latest word information can be fulfilled. Accordingly, convenience for the user is improved, and a flexible update process can be supported.

### Second Embodiment

The second embodiment is different from the first embodiment in that the user designates a dictionary to be updated, and a message to ask whether or not to update a word registered in the dictionary is presented to the user. By this feature, the user can update a word for each desired dictionary.

A dictionary update apparatus according to the second embodiment is the same as the apparatus according to the first embodiment, except that a user instruction is input to the extractor 103.

The dictionary update process of the dictionary update apparatus according to the second embodiment will be explained with reference to the flowchart of FIG. 5.

In step S501, the extractor 103 receives a dictionary designation from a user.

In step S502, the extractor 103 determines whether there is an unacquired word entry in the latest version of the dictionary designated by the user. If there is an unacquired word entry, the process proceeds to step S503, and if there is no unacquired word entry, i.e., all the words in the dictionary have been processed, the operation ends.

In step S503, the extractor 103 selects a word ID and the corresponding update history ID registered in the dictionary designated by the user.

In step S504, the extractor 103 determines whether or not the update history ID selected in step S503 matches the latest update history ID of the corresponding word ID stored in the word information database 101. If the selected update history ID does not match that stored in the word information database 101, the process returns to step S502 and the same process is repeated.

In step S505, the presenter 104 presents a message to the user to ask whether or not to update the selected update history ID.

In step S506, the updater 105 determines whether a user instruction to update the update history ID is received. If a user's update instruction is received, the process proceeds to step S507. If there is no user's update instruction, or an instruction to not update is received, the process returns to step S502, and the same process is repeated.

In step S507, the updater 105 updates the selected update history ID to the latest update history ID stored in the word information database 101. The dictionary update process of the dictionary update apparatus according to the second embodiment is completed by the above process.

According to the second embodiment described above, the word information can be updated for a dictionary designated by the user, and updating can be supported for each dictionary. Accordingly, a flexible update process can be achieved.

### Third Embodiment

The third embodiment is different from the first or second embodiment in that an update pattern indicating how to update word information included in each dictionary is predetermined, and if a user's instruction to update a particular word is received, the update process is executed based on the update pattern.

A dictionary update apparatus according to the third embodiment is the same as the apparatus according to the first embodiment, except for information to be stored in the dictionary management database 102 and the process executed at the updater 105.

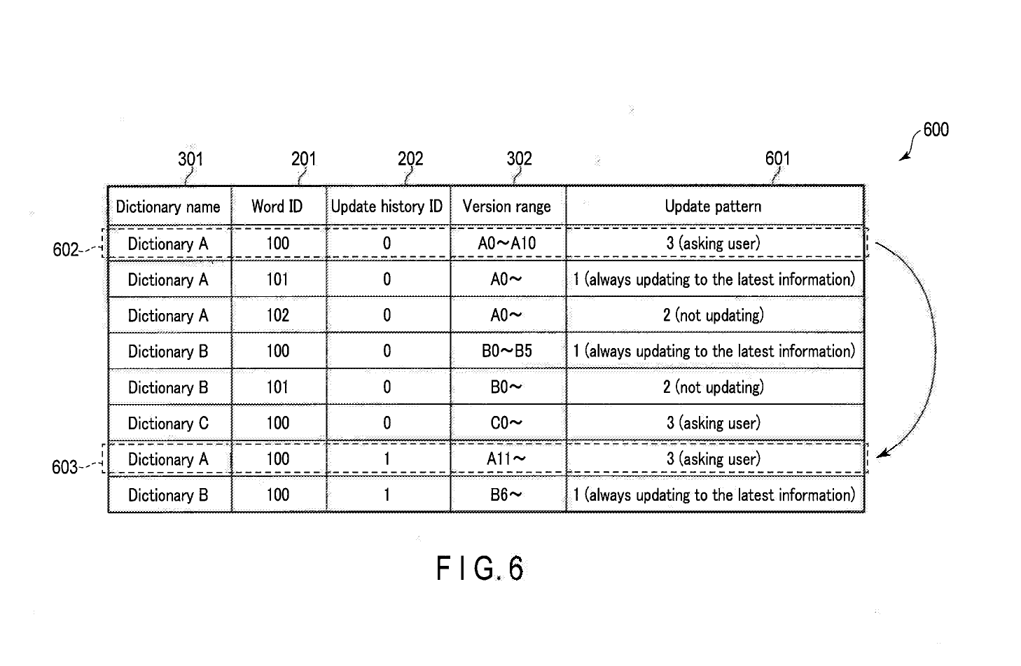

An example of a data structure stored in the dictionary management database 102 according to the third embodiment will be explained with reference to FIG. 6.

The dictionary management database 102 as shown in FIG. 6 stores a dictionary name 301, a word ID 201, a update history ID 202, a version range 302, and a update pattern 601 that are associated with each other. The update pattern 601 that indicates how to update word information is preset for each word ID. For example, the update pattern 601 includes “1 (always updating to the latest information)”, “2 (not updating)” and “3 (asking user)”. This embodiment adopts three patterns, however; two patterns, or four or more patterns can be adopted.

The updater 105 receives one or more update candidates from the extractor 103, and performs an update process to the one or more update candidates based on the update pattern associated with each update candidate. For example, if the update pattern 601 is “1 (always updating to the latest information)”, the updater 105 updates the update history ID stored in the dictionary management database 102 to the latest update history ID so that the corresponding word used in the dictionary has the latest word information, without asking the user whether or not to update the word information.

If the update pattern 601 is “2 (not updating)”, the updater 105 does not ask the user whether or not to update the word information, or to update the corresponding word.

If the update pattern 601 is “3 (asking user)”, the updater 105 asks the user whether or not to update the word information, and executes the process in the same manner as in the first embodiment.

If the word information is updated for a particular word ID, the update pattern may be continuously used for the particular word ID (i.e., the same update pattern may be successively used). Specifically, if a dictionary entry 602 shown in FIG. 6 is updated to a dictionary entry 603, an update pattern 601 for the dictionary entry 602 is “3 (asking user)”, the same update pattern 601, “3 (asking user)”, may be used for the dictionary entry 603.

According to the third embodiment described above, since the update pattern is set for each word, the need for asking the user whether or not to update is eliminated for words that the user has determined as not being updated or are always being updated. This feature can reduce inconvenience to the user, and can improve efficiency of the updating process, thereby supporting a flexile update process.

### Fourth Embodiment

In the aforementioned embodiments, it is assumed that the word information and the update history to be stored in the word information database 101 are already determined as external processing. Namely, it is determined whether the word information used in a dictionary is to be updated based on the information of the word information database that has been externally updated. On the other hand, the fourth embodiment is different from the aforementioned embodiments in that it is assumed that word information is updated at a dictionary, and the word stored in the word information database 101 and the dictionary management database 102 is updated based on the update word information in the dictionary.

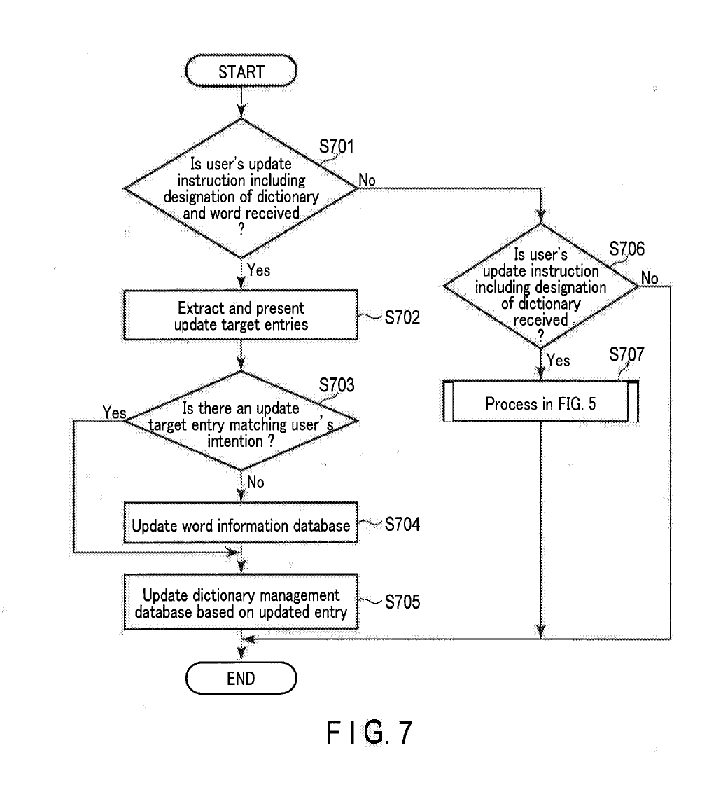

The operation of the dictionary update apparatus according to the fourth embodiment will be explained with reference to the flowchart of FIG. 7.

In step S701, the updater 105 determines whether or not a user's update instruction including designation of a dictionary and a word is received. If an update instruction is received, the process proceeds to step S702; if not, the process proceeds to step S706.

In step S702, the extractor 103 extracts from the word information database 101 all word entries (also referred to as update target entries) having the same word ID as that of the designated word, and the update history ID different from that of the designated word. The presenter 104 presents the update target entries to the user.

In step S703, the updater 105 detects whether or not there is an update target entry to which the user's intended update has been made (referred to as an updated entry) among the update target entries extracted in step S702. If no updated entry is included, the process proceeds to step S704; if there is an updated entry, the process proceeds to step S705.

In step S704, the updater 105 adds a new word entry in which the word information has been updated to the word information database 101 as an updated entry, based on a user input. Namely, a word entry which has the same word ID as the designated word and the latest update history ID, and word information which has been updated based on the user input, is stored in the word information database 101 as an updated entry.

In step S705, the updater 105 updates the dictionary management database 102 based on the updated entry. Specifically, the update history ID stored in the dictionary management database 102 is updated to the update history ID of the updated entry.

In step S706, the updater 105 determines whether or not a user's designation for a dictionary is received. If a user's designation for a dictionary is received, the process proceeds to step S707; if not, the process ends.

In step S707, the dictionary update process described in the second embodiment as shown in FIG. 5 is performed. The dictionary update process of the dictionary update apparatus according to the fourth embodiment is completed by the above process.

According to the fourth embodiment described above, word information of a particular word in the word information database can be updated as the word information of the particular word in any dictionary is updated. Accordingly, a flexible update process can be achieved.

### Fifth Embodiment

In the aforementioned embodiments, a unique ID is assigned to a word; on the other hand, in the fifth embodiment, a unique ID is assigned to a word entry of the word information database 101.

A dictionary update apparatus according to the fifth embodiment is the same as the apparatus according to the first embodiment, except for information to be stored in the word information database 101 and the dictionary management database 102, and the process executed at the extractor 103 and the updater 105.

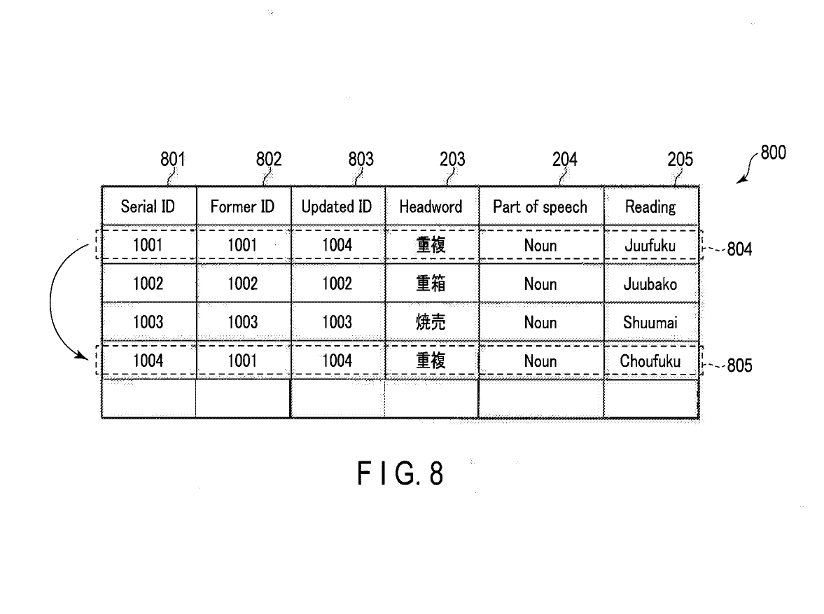

An example of a data structure stored in the dictionary management database 101 according to the fifth embodiment will be explained with reference to FIG. 8.

Table 800 shown in FIG. 8 stores word entries in each of which a serial ID 801, a former ID 802, an updated ID 803, a headword 203, a part of speech 204, and a reading 205 are associated with each other.

The serial ID 801 is an identifier uniquely assigned to each word entry. The former ID 802 is a serial ID of an original word entry before word information is updated. The updated ID 803 is a serial ID of a word entry after word information is updated.

For example, table 800 stores a word entry in which a serial ID 801, “1001”, a former ID 802, “1001”, an updated ID 803, “1004”, a headword 203, “ [symbol] ”, a part of speech 204, “Noun”, and a reading 205, “juufuku”, are associated with each other.

By referring to the former ID 802 and the updated ID 803, it is recognized which serial ID is updated to which serial ID. If the serial ID 801 is identical to the former ID 802, it indicates that the word entry has the original word information. If the serial ID 801 is identical to the updated ID 803, it indicates that the word entry has the latest word information.

For example, as shown in FIG. 8, if a word entry 804 is updated to a word entry 805, the updated ID 803 “1001” of the word entry 804 is changed to “1004”.

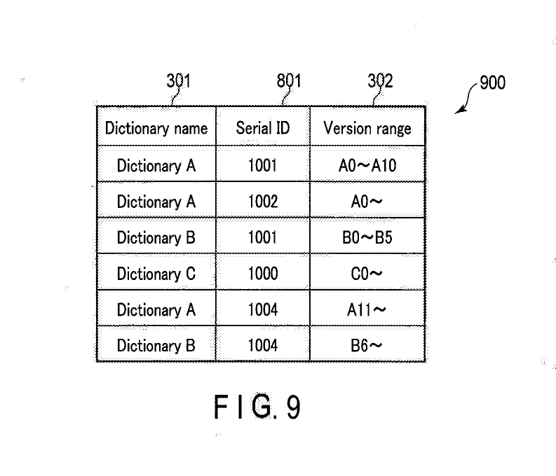

Next, an example of a data structure stored in the dictionary management database 102 according to the fifth embodiment will be explained with reference to FIG. 9.

Table 900 according to the fifth embodiment stores dictionary entries in each of which a dictionary name 301, a serial ID 801, and a version range 302 are associated with each other. For example, table 900 stores a dictionary entry in which a dictionary name 301, “Dictionary A”, a serial ID 801, “1001”, and a version range 302, “A0˜A10”, are associated with each other.

An example shown in FIG. 8 will be explained. If the word entry 804 is updated to the word entry 805, the extractor 103 extracts from the word information database 101 one or more word entries as update candidates in which the serial ID 801 is different from the updated ID 803.

If word information used in Dictionary A is to be updated based on the user instruction, the updater 105 adds a new dictionary entry having a dictionary name 301, “Dictionary A”, a serial ID 801, “1004”, and a version range 302, “A11˜” to the dictionary management database 102. By associating the serial ID 801 with the dictionary name, it is possible to specify particular word information stored in the word information database 101, even though the dictionary management database 102 does not store information on update history. This facilitates easy data management.

In the above example, the latest update information is prioritized. For example, if the reading of a word “ [symbol] ” has been updated from “juufuku” to “choufuku”, the latest information indicates “choufuku” as the reading of the word. However, there may be a case where both readings, “juufuku” and “choufuku”, should be adopted. In this case multiple readings can be associated with a word by associating a plurality of updated IDs with the word.

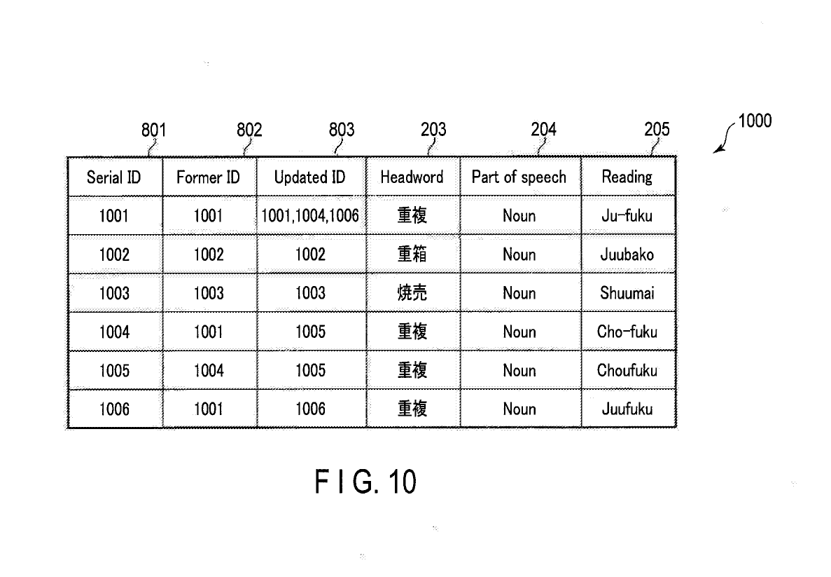

An example of the data structure of the word information database 101 when multiple readings are associated will be explained with reference to FIG. 10.

Table 1000 shown in FIG. 10 is similar to table 800 shown in FIG. 8 except that a plurality of updated IDs 803 are associated with a serial ID.

In the example shown in FIG. 10, the reading of a serial ID 801, “1001” is “ju-fuku”. The word entry of the serial ID 801 “1001” is updated to be a serial ID 801 “1004” that indicates “cho-fuku” as a reading. In this case, an updated ID 803 “1004” is added to the word entry of the serial ID 801 “1001”.

After that, the word entry of the serial ID 801 “1001” is updated to be a serial ID 801 “1006” that indicates “juufuku” as a reading. In this case, an updated ID 803 “1006” is added to the word entry of the serial ID 801 “1001”.

In addition, the word information of the serial ID 801 “1004” indicates the different serial ID “1005” as the updated ID. This means that the word information of the serial ID 801 “1004” is not the latest information. That is, the reading “choufuku” of the serial ID 801 “1005” is referred to as the latest update word information for the serial ID 801 “1004”. As a result, for the word entry of the serial ID 801 “1001”, the readings “ju-fuku”, “choufuku” and “juufuku” are applied.

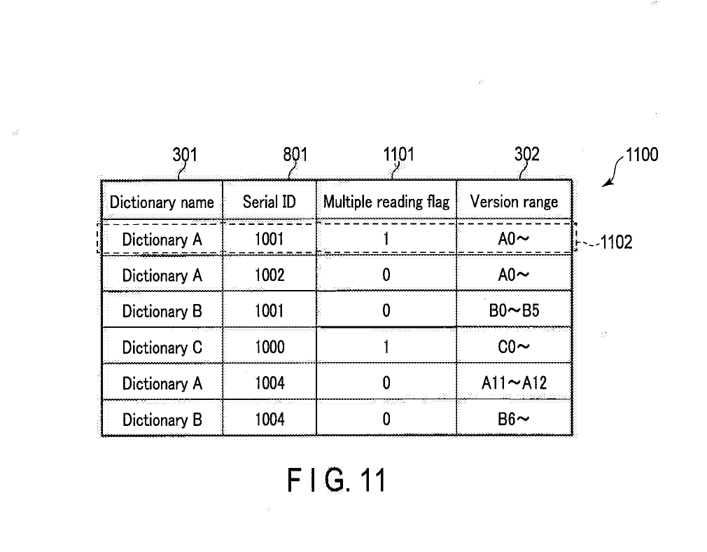

Next, an example of the data structure of the dictionary management database 102 when multiple readings are associated will be explained with reference to FIG. 11.

Table 1100 shown in FIG. 11 stores dictionary entries in each of which a dictionary name 301, a serial ID 801, a multiple reading flag 1101, and a version range 302 are associated with each other.

The multiple reading flag 1101 indicates whether multiple readings of a word are supported. The multiple reading flag 1101, “1”, represents that multiple readings are supported. In the example of FIG. 11, the multiple reading flag 1101 for a dictionary entry 1102 is “1”. This indicates that multiple readings of the serial ID 801 “1001” are supported in Dictionary A. For example, in the case of the word information database 101 shown in FIG. 10, the word entries of the serial IDs 801 “1001”, “1004”, and “1006” included in the updated ID 803 become valid.

Even though a reading corresponding to the latest update history is used as word information of a dictionary in an initial setting, a user may expect multiple readings of a word to be provided later. In this case, the version range 302 associated with the multiple reading flag “1” in the dictionary management database 102 may be modified to be the version range currently being used. For example, if a version range for a particular word ID is “A0˜A12”, the updater 105 sets the multiple reading flag for the particular word to be “1” and updates the version range to be “A0˜” upon reception of a user instruction. By this process, the word information of the word ID to which the version range has been changed becomes currently valid, and the word information of the updated ID of the word in the word information database 101 can be referred to. Accordingly, multiple readings for the word can be provided.

According to the fifth embodiment describe above, the word information is managed by using the serial ID included in the word information database, thereby facilitating easy management without the need for managing the word information by the word ID and the update history ID. In addition, by associating the serial ID with the updated ID, multiple readings for a word can be supported.

In the above explanation, the reading of a word is updated based on the word ID associated with a headword; however, the similar update process can be performed in the case where a headword (kanji characters or Chinese characters) is updated based on the word ID associated with a reading. For example, in the case where the reading “seibutsu” is associated with the headword “ [symbol] ”, the headword can be updated to “ [symbol] ” by using the update support apparatus 100 according to the aforementioned embodiments.

The flow charts of the embodiments illustrate methods and systems according to the embodiments. It is to be understood that the embodiments described herein can be implemented by hardware, circuitry, software, firmware, middleware, microcode, or any combination thereof. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. An update support apparatus, comprising:
a first storage that stores word entries in each of which an identifier to identify a word, word information for the word, and an update history of the word information are associated with each other;
a second storage that stores dictionary entries in each of which the identifier and the update history are associated with each other for each version of one or more dictionaries which use the word information;
an extractor that extracts one or more update candidates from the second storage, the one or more update candidates each being a dictionary entry having the identifier stored in the first storage and an update history different from the update history stored in the first storage; and
a presenter that presents the one or more update candidates to a user.

2. The apparatus according to claim 1, further comprising an updater that updates an update history of an update candidate designated by the user from among the one or more update candidates to a latest update history by referring to the first storage

3. The apparatus according to claim 2, wherein
the second storage further stores an update pattern indicating a pattern of an update process of the word information for a corresponding identifier, and
the updater performs the update process to the one or more update candidates based on the update pattern.

4. The apparatus according to claim 2, wherein the updater updates the word information and the update history stored in the first storage in accordance with an instruction from the user.

5. The apparatus according to claim 2, wherein the second storage further stores a version range indicating a version of each dictionary for a corresponding identifier,
the updater updates a version range associated with each of the one or more update candidates from a version of a dictionary when the corresponding word information is started to be used for a version immediately before a latest version, and
the second storage stores the identifier, the latest update history and the latest version of the dictionary are associated with each other.

6. The apparatus according to claim 1, wherein the extractor extracts the one or more update candidates for a dictionary designated by the user.

7. The apparatus according to claim 1, wherein
the first storage stores a word entry in which the identifier, the word information and the update history are associated with each other, and
the second storage stores information for one or more dictionaries that use the word entry.

8. An update support apparatus, comprising:
a first storage that stores word entries in each of which word information for a word, a serial ID to identify the word information, a former ID and an updated ID are associated with each other, the former ID indicating a serial ID before the word information is updated, the updated ID indicating a serial ID after the word information is updated;
a second storage that stores a dictionary name and the serial ID associated with each other for one or more dictionaries that use the word information;
an extractor that extracts one or more update candidates from the first storage, each of the one or more update candidates being a word entry having the serial ID different from the updated ID; and
a presenter that presents the one or more update candidates to a user.

9. The apparatus according to claim 8, further comprising an updater that adds a serial ID of an update candidate designated by the user from among the one or more update candidates to the second storage.

10. The apparatus according to claim 8, wherein the first storage stores one or more serial IDs of word entries having a particular serial ID as the former ID to the updated ID of a word entry of the particular serial ID.

11. An update support method, comprising:
storing, in a first storage, word entries in each of which an identifier to identify a word, word information for the word, and an update history of the word information are associated with each other;
storing, in a second storage, dictionary entries in each of which the identifier and the update history are associated with each other for each version of one or more dictionaries which use the word information;
extracting one or more update candidates from the second storage, the one or more update candidates each being a dictionary entry having the identifier stored in the first storage and an update history different from the update history stored in the first storage; and
presenting the one or more update candidates to a user.

12. The method according to claim 11, further comprising updating an update history of an update candidate designated by the user from among the one or more update candidates to a latest update history by referring to the first storage.

13. The method according to claim 12, further comprising storing, in the second storage, an update pattern indicating a pattern of an update process of the word information for a corresponding identifier, wherein
the updating the update history performs the update process to the one or more update candidates based on the update pattern.

14. The method according to claim 12, wherein the updating the update history updates the word information and the update history stored in the first storage in accordance with an instruction from the user.

15. The method according to claim 12, further comprising storing, in the second storage, a version range indicating a version of each dictionary for a corresponding identifier, wherein
the updating the update history updates a version range associated with each of the one or more update candidates from a version of a dictionary when the corresponding word information is started to be used for a version immediately before a latest version, and
the storing in the second storage stores the identifier, the latest update history and the latest version of the dictionary are associated with each other.

16. The method according to claim 11, wherein the extracting extracts the one or more update candidates for a dictionary designated by the user.

17. The method according to claim 11, wherein
the storing in the first storage stores a word entry in which the identifier, the word information and the update history are associated with each other, and
the storing in the second storage stores information for one or more dictionaries that use the word entry.

18. A non-transitory computer readable medium including computer executable instructions, wherein the instructions, when executed by a processor, cause the processor to perform a method comprising:
storing, in a first storage, word entries in each of which an identifier to identify a word, word information for the word, and an update history of the word information are associated with each other;
storing, in a second storage, dictionary entries in each of which the identifier and the update history are associated with each other for each version of one or more dictionaries which use the word information;
extracting one or more update candidates from the second storage, the one or more update candidates each being a dictionary entry having the identifier stored in the first storage and an update history different from the update history stored in the first storage; and
presenting the one or more update candidates to a user.
